(19) United States
(12) Patent Application Publication
(10) Pub. No.: US 2013/0047480 A1
(43) Pub. Date: Feb. 28, 2013

(54) Toki-Top. A New Symbol And Its Utilization In The Field Of Social Interaction. The Toki-Top Symbol As A Method For Initiation Of Direct Human Communication

(71) Applicant: Raisa Kelmanson, Los Angeles, CA (US)

(72) Inventor: Raisa Kelmanson, Los Angeles, CA (US)

(21) Appl. No.: 13/218,396

(22) Filed: Aug. 25, 2011

(51) Int. Cl. G09F 7/00

(52) U.S. Cl. 40/584

(57) ABSTRACT

The concept of this invention—is creating a new method of social interaction by establishing a symbol/sign/logo, which would encourage people to seek direct human contact, while identifying the individuals who are open to direct communication. The symbol should serve as an informative tool, letting the public know that a person who has the symbol on any of his personal items is approachable, and the message (if any), handwritten next to the symbol—is a real-life talk, a real-life message. Some of these people may need help, while others may want to help or just have a conversation. This new method of social interaction serves as an opposite to the social online networking. The utilization of the Toki-Top (proposed nickname) symbol should not limited by any age group, social, ethnical, religious, or any other affiliation.

### CROSS-REFERENCE TO RELATED APPLICATION

Not applicable.

### STATEMENT REGARDING FEDERALLY SPONSORED RESEARCH OR DEVELOPMENT

Not Applicable.

### BACKGROUND OF THE INVENTION

Psychology.

Social studies.

Human behavior and the challenges it undergoes in relation to the progress of technology.

New form of direct human interaction as an opposite to social online networking.

### REFERENCE TO SEQUENCE LISTING, A TABLE, OR A COMPUTER PROGRAM LISTING COMPACT DISC APPENDIX

Not Applicable

### BRIEF SUMMARY OF THE INVENTION

A new method of social interaction as a tool to potentially eliminate the individual's detachment from society, and reduce the risk of individual's depersonalization and alienation.

Establishing a universal symbol (sign/logo) to encourage direct human interaction.

The new symbol as an informative tool. It is to identify the individuals, who are open to direct communication.

Creating the nickname for the symbol. The proposed nickname is Toki-Top (TokiTop).

The utilization of the new symbol. The Toki-Top symbol will be printed on the t-shirts, shopping bags, stickers, coffee cups, other items. It will be displayed in the public places such as restaurants, shopping malls, parks, employee's cafeterias, hospitals, at the airports, and so on, in order to create the areas, recognized by the public, as the comfort zone for direct communication with others.

The topics, the individuals want to discuss with others, may be handwritten next to the Toki-Top symbol. The presence of the symbol next to any message is to let others know—it is a real life talk, a real life message.

### BRIEF DESCRIPTION OF THE SEVERAL VIEWS OF THE DRAWING

The proposed design of the symbol is secondary to its purpose, and it may vary.

Prior to the public getting familiar with the symbol and its concept, the use of the full name “Toki-Top” is suggested (FIG. 1 or FIG. 2).

The abbreviated version “TT” (FIG. 3) is possible.

FIG. 4 is an example of a personal message handwritten on the shopping bag.

FIG. 5 is an example of how the symbol may be utilized at the coffee place.

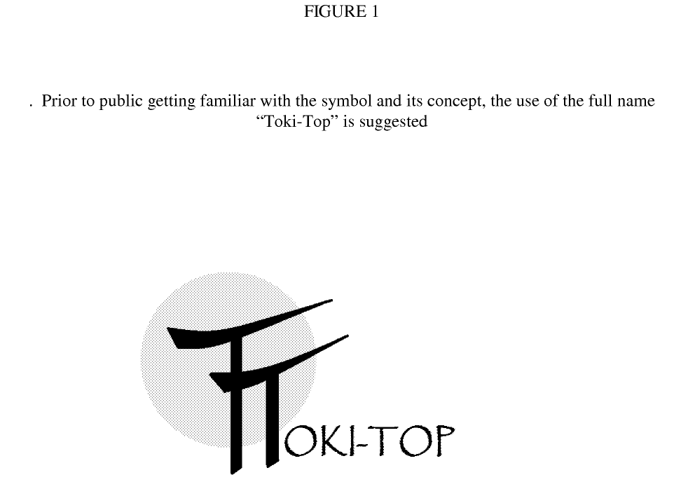

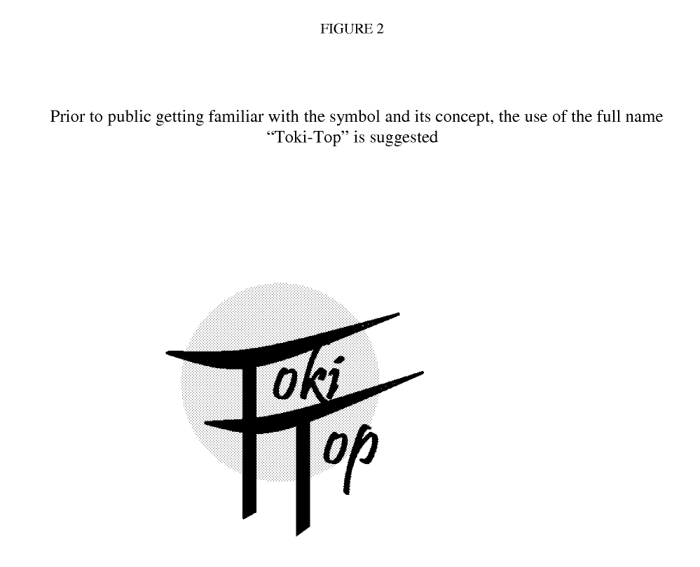

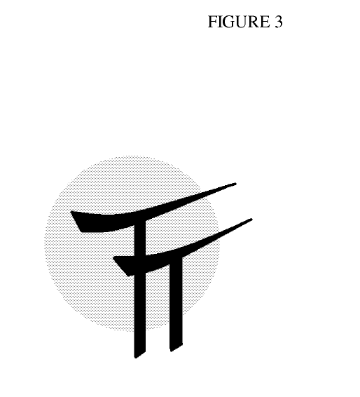

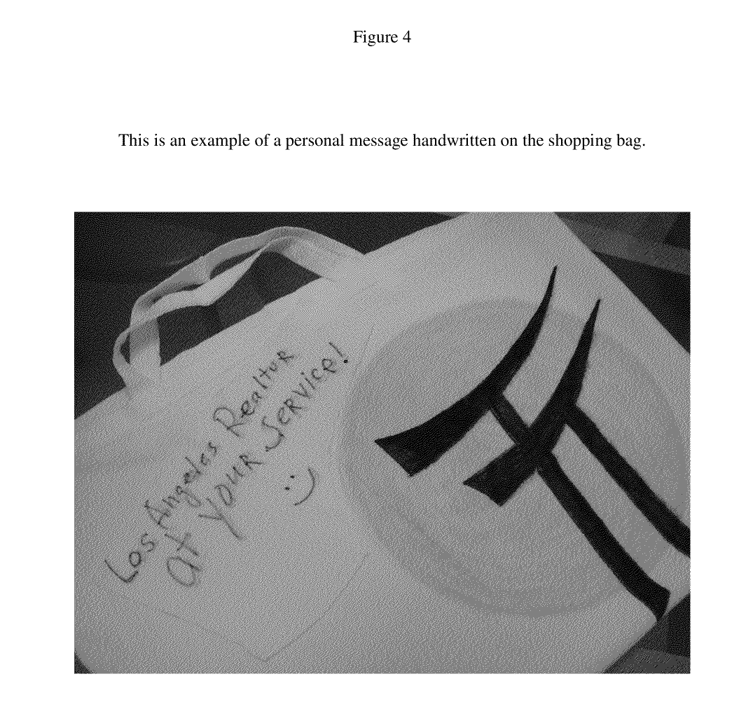

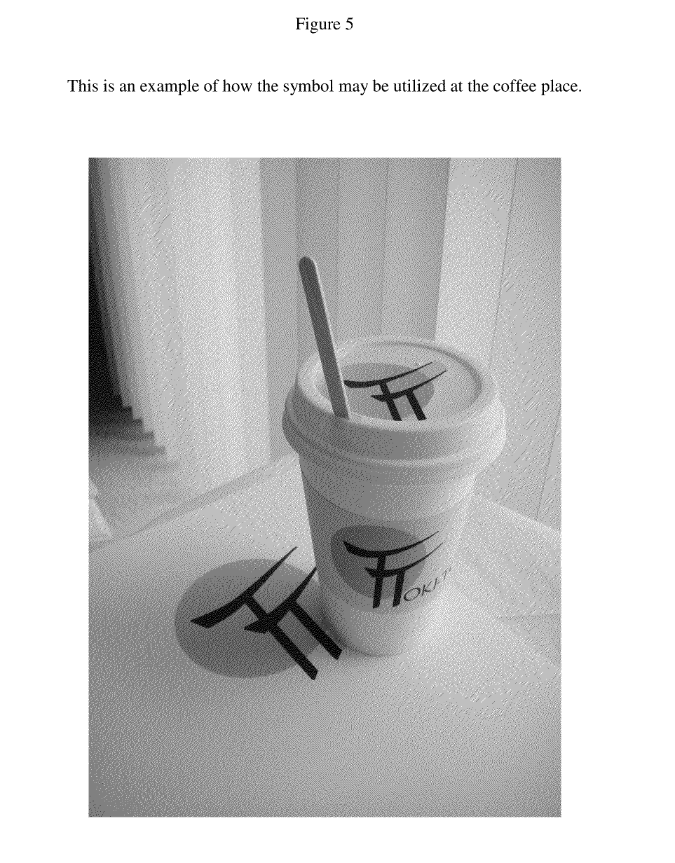

The proposed color combination for the symbol is—black and yellow. The letters are in black color, over the bright yellow circle (the stylized image of the sun).

The size of the image depends on the size of the surface it is placed on, and the intentions of the users (how visible they want it to be).

### DETAILED DESCRIPTION OF THE INVENTION

Modern technologies bring changes to our needs and social behavior. They improve the quality of men's life, yet, once in a while we see the adverse effects. One of the negative impacts brought upon us by the progress—is a rapidly increasing individual's detachment from the society. Most of our interactions with friends and relatives take place online and not in person today!

In January of 2011, Pope Benedict gave his blessing to social networking. The pontiff acknowledged its potential, but also pointed out the danger of always being available online but “less present to those whom we encounter in our everyday life.” He warned people about the risks of depersonalization and alienation.

More than ever difficult economy condition makes the matter worse. Many people have no one to talk to, to seek help or advice from, while having hundreds or even thousands of online “friends”! Some problems could possibly be solved, if we only had a chance to talk to anyone while shopping at the mall, having a sandwich at the local bistro, filling a tank at the gas station, just walking on the street or even driving . . .

The concept of this invention is to establish a symbol/sign/logo, which would encourage people to seek direct human contact, while identifying the individuals who are open to direct communication. The proposed symbol should become a part of everyday life by enabling people to interact with others and assure they won't be rejected. It should serve as an informative tool, letting everyone know that the person who has the symbol on any of his personal items (clothing, accessories, bags), has a sticker attached to his coffee cup, his car, and so on—this individual is approachable, and the message, written next to the symbol—is a real-life talk, a real-life message. Some of these people may need help, while others may want to help or just have a conversation.

The proposed design of the symbol is secondary to its purpose, and it may vary. Prior to public getting familiar with the symbol and its concept, we suggest the use of the full name “Toki-Top” (FIG. 1 and FIG. 2). It also may be abbreviated to “TT” (FIG. 3). The abbreviated version is described as follows: double letter “T” in black color, with one “T” overlapping another, over the bright yellow/golden yellow circle. While the proposed color combination is—black and yellow, the size of the image shall only depend on the size of the surface it is on, and the intentions of the users (how visible they want it to be).

The utilization of this invented symbol shall become an entirely new, and opposite to the social online networking, method of social interaction. There is also one very important advantage of utilizing the Toki-Top symbol as the method to communicate: this method it is not limited by any age group, social, ethnical, religious, or any other affiliation. It could become a universal sign of the new form of communication and social behavior.

1. Creation of a new method of social communication.

2. Adoption of a universal symbol (sign/logo) as an informative tool to utilize the new method of social communication.

3. Creating a nickname for the symbol. The created name is—Toki-Top (TokiTop).

4. The Toki-Top symbol is to identify the individuals, who are open to direct human interaction.

5. The Toki-Top symbol is to inform about the designated areas in the public places.

6. The Toki-Top symbol is to validate any handwritten note/statement as a real life message.
